(19) United States
(12) Patent Application Publication
(10) Pub. No.: US 2022/0200791 A1
(43) Pub. Date: Jun. 23, 2022

(54) METHOD FOR ENCRYPTING AND STORING COMPUTER FILES AND ASSOCIATED ENCRYPTION AND STORAGE DEVICE

(71) Applicant: SAGEMCOM BROADBAND SAS, Rueil Malmaison (FR)

(72) Inventors: Sylvain LE ROUX, Rueil Malmaison (FR); Florent DIONISI, Rueil Malmaison (FR)

(73) Assignee: SAGEMCOM BROADBAND SAS, Rueil Malmaison (FR)

(21) Appl. No.: 17/553,213

(22) Filed: Dec. 16, 2021

(30) Foreign Application Priority Data
Dec. 18, 2020 (FR) 2013639

(51) Int. Cl. H04L 9/08; H04L 9/14

(52) U.S. Cl. CPC H04L 9/0825; H04L 9/14; H04L 9/0894

(57) ABSTRACT

A method for storing computer files in encrypted form, executed by a “key store” device and includes: establishing a list of pairs of keys wherein each of the pairs of keys is associated with a unique identifier authorized to access a computer file; receiving by an encryption key, then encrypting as many encrypted versions as there are public keys; recording an encrypted version of the computer file in a storage space accessible from the key store; a header or another part of the encrypted version of the computer file having the encrypted versions of the encryption key, each of the encrypted versions associated in the header with the identifier of the client, and in a list of files encrypted and stored under the control of the key store, as well as a pointer to an encrypted version of the file recorded in the file storage space.

### TECHNICAL FIELD

The present invention relates to the management, in a local area network, of encryption keys useful for the encryption of computer files, for purposes of secure storage of these files. The invention relates more particularly to a centralised management of encryption keys for the encryption and storage in encrypted form of computer files, in particular when a plurality of users of the same local area network share files and gain access thereto from a plurality of devices.

### PRIOR ART

Many tools exist that make it possible to generate and record keys or passwords in a centralised manner, such as for example the computing tool called KeePass2. These tools constitute password databases, which store the passwords in an encrypted form, which is particularly useful since very many applications require protection by password and because it is necessary, for obvious security reasons, to use separate passwords for each application. These tools require knowledge of a main password, sometimes referred to as “master password” and store a password database in the equipment (computer, smartphone, tablet, for example) of the user.

Sharing this information therefore requires sharing a file constituting the password database as well as sharing the main password. This does not allow a simple sharing, for example in the case of a use of multiple applications, between various users of various items of computing equipment connected to a local area network in a home. In addition, when this information has been communicated to a person, it is not possible to revoke rights specifically for this person, and it is the revocation of all the rights that is then necessary, with an impact on all the users of passwords contained in the password database.

Moreover, in relation to the encryption of computer files, tools exist that make it possible to encrypt a file so that it is then decipherable by various users. If these tools relate mainly to the encryption of files, they do not use a centralised management of the encryption keys. The situation can be improved.

### DISCLOSURE OF THE INVENTION

The aim of the invention is to propose a solution for encrypting and storing files and making it possible to simply share access to encrypted documents between a plurality of users.

For this purpose, a method is proposed for encrypting and storing a computer file, the method being implemented by a device, known as a “key store”, for securing accesses to said computer file, the method comprising:

establishing a list of n pairs of keys, each pair of keys comprising respectively a so-called private key and a so-called public key, wherein each of the pairs of keys is associated with a unique identifier of an i^{th} client authorised to access said computer file,

receiving said computer file and encrypting it as an encrypted version of the computer file, by means of a key for encrypting the computer file,

encrypting the encryption key in as many encrypted versions as there are public keys in the pairs of keys, each of the encrypted versions of the encryption key being encrypted with one of the public keys in the pairs of keys of the clients authorised to access the file F,

recording an encrypted version of the computer file, encrypted by means of said key for encrypting the computer file, in a file storage space accessible from the key store, the encrypted version of the computer file being associated with the encrypted versions of the encryption key,

associating the file, in a list of files encrypted and stored under the control of the key store, with one or more unique identifiers of pairs of keys, as well as with a pointer to an encrypted version of the computer file recorded in the file storage space.

Thus it is advantageously possible to revoke access rights granted to one of the users, without impact for the others.

A second advantage lies in the fact that it is possible to ensure the confidentiality of information contained in computer files when the latter are stored in one or more storage devices that do not natively offer this possibility.

A third advantage is that a centralised encryption is implemented according to the user or users authorised to access a file stored in the file storage space. Thus, by virtue of the method described, access to a file and deciphering thereof are linked to the validity of the private key of the requesting client, who may be the client originating the storage of the file or another client authorised to access this file. A client being defined as a user or as a combination of a user working on a given device.

Another advantage is that, in the case of revocation of a key, an encrypted file associated with this key has its encryption updated with the rest of the still valid keys associated with clients having a right of access to this file.

The method according to the invention may also comprise the following features, considered alone or in combination:

The method is defined such that:

establishing the list of n pairs of keys comprises an addition of an n^{th} pair of keys associated with a unique identifier of an n^{th} client authorised to access the computer file in the list of pairs of keys, and/or wherein

an identifier of an i^{th} pair of keys is inserted in the list of files encrypted and stored by said key store, in association with said computer file for purposes of granting to an i^{th} client newly authorised to access the computer file a right of access to the computer file. Thus rights of access to a file can be granted to a newly authorised client to whom a pair of keys had not been attributed, or to a client to whom a pair of keys is already attributed but who does not yet have rights of access to this file.

The method is defined such that:

establishing the list of n pairs of keys comprises a removal of an i^{th} pair of keys associated with a unique identifier of an i^{th} client authorised to access the computer file in the list of pairs of keys, and/or wherein

an identifier of an i^{th} pair of keys is removed from the list of encrypted files and stored by said key store, in association with said computer file for the purpose of preventing the i^{th} client, previously authorised, having access to the computer file. Thus rights of access to a file can be withdrawn from a client who is no longer authorised for access to this file and for whom the pair of keys remains valid and/or for whom the pair of keys is revoked.

The unique identifier of a client comprises a user name and/or a password and/or a derivative of these elements. It is thus possible to increase the security of the accesses to the key store by allowing an authentication of the client when a client is connected to the key store, under the control of the latter.

One or more unique identifiers of a client comprise a unique identifier of a device used by a user of the key store, in particular of the type consisting of an MAC address of an electronic device. It is thus possible to increase the security of the accesses to the key store by allowing an authentication of the client as well as of the device used when a client is connected to the key store, under the control of the letter.

The method comprises a step of authenticating a client authorised to access the key store verifying that the client is connected to the key store by means of a local area network of the LAN type, by means of a cable connection or an encrypted wireless connection. It is thus possible to secure the accesses to the encrypted recorded files by limiting them to connected clients present in an environment that comprises the local area network of the LAN type, such as a home or a company for example.

The key store used by the method is embedded in equipment of the domestic network gateway type or equipment of the server type, such as a cloud server. Thus the number of items of equipment useful for implementing the file encryption and storage method is limited and the centralised management of the file encryption and storage method is implemented by equipment the purpose of which is already to appear central in a local area network or seen from a local area network.

Another object of the invention is a device, known as a “key store”, for securing access to at least one computer file, the key store comprising electronic circuits comprising:

a module for establishing a list of n pairs of keys, each first pair of keys comprising respectively a so-called private key and a so-called public key, wherein each of the pairs of keys is associated with a unique identifier of an i^{th} client authorised to access said computer file,
a communication interface configured for receiving the computer file and an encryption module configured for encrypting the computer file as an encrypted version of the computer file, by means of a key for encrypting the computer file, and configured for encrypting the encryption key in as many encrypted versions as there are public keys, each of the encrypted versions of the encryption key being encrypted with one of the public keys of the pairs of keys of the clients authorised to access the file F,

a module for recording an encrypted version of the computer file by means of the key for encrypting the computer file, in a file storage space accessible from the key store, the encrypted version of the computer file being associated with the encrypted versions of the encryption key,

a module for associating the file, in a list of files encrypted and stored under the control of the key store, with one or more unique identifiers of pairs of keys, as well as with a pointer to an encrypted version of the computer file recorded in the file storage space.

Finally, an object of the invention is a computer program product comprising program code instructions for performing the steps of the aforementioned method, when the program is executed by a processor, as well as an information storage support device comprising such a computer program product.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically a computer network of the local area network type wherein a method for encrypting and storing computer files according to one embodiment of the invention is implemented;

FIG. 2 illustrates a concept of “client” of the service implemented by the method according to one embodiment, in the computer network already shown on FIG. 1;

FIG. 3 is a representation of a list of pairs of encryption key used by the method according to one embodiment;

FIG. 4 is a representation of a list of computer files the encryption and storage of which are implemented by a method according to one embodiment;

FIG. 5 is a flow diagram showing steps of a method for encrypting and storing computer files, according to one embodiment of the invention;

FIG. 6 is an outline diagram showing an access-securing device known as a “key store” configured for implementing a method for encrypting and storing computer files, as illustrated on FIG. 5, according to one embodiment.

### DETAILED DISCLOSURE OF EMBODIMENTS

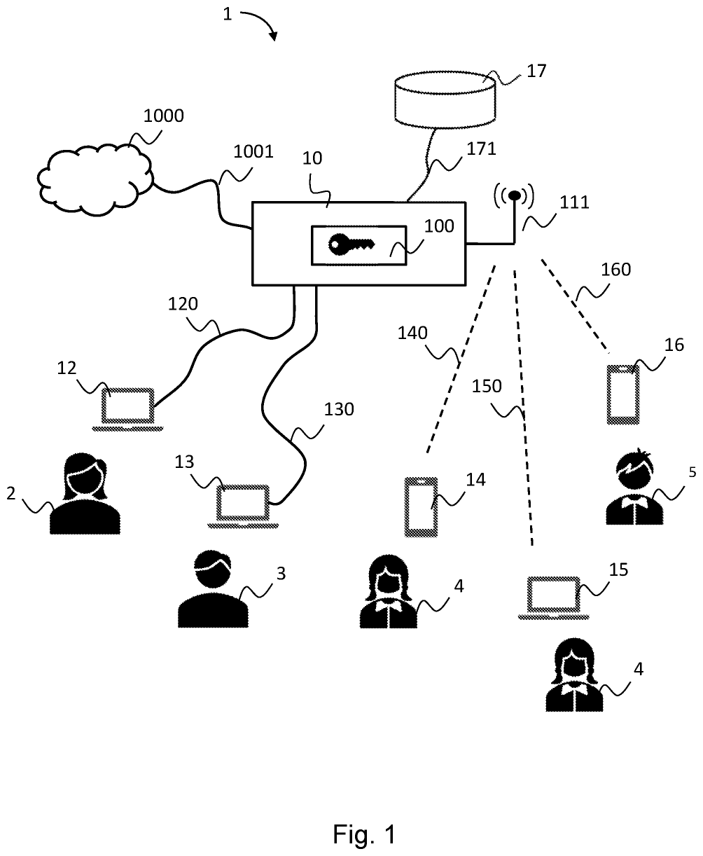

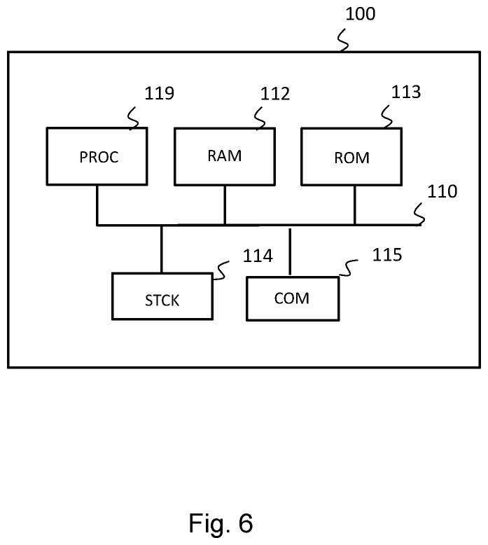

FIG. 1 illustrates schematically a local area network 1 of the LAN network type. The local area network 1 is a domestic network that comprises network gateway equipment 10, typically of the residential network gateway type. The network gateway 10 is configured for connecting the local area network 1 to a wide area network 1000, by means of a connection link 1001. The wide area network 1000 is a network of the WAN type (“Wide Area Network”). According to one embodiment of the invention, the wide area network 1000 is the internet. The connection link 1001 can be implemented in the form of a telephone subscriber line, and the connection uses for example ADSL technology (the abbreviation for “Asymmetric Digital Subscriber Line”), a connection of the optical fibre type or a wireless connection of the fixed wireless access type based on 4G and/or 5G access technologies for example. These examples not being limitative. Electronic devices 12, 13, 14, 15 and 16, of various types, are configured for being connected to the local area network 1 by means of the network gateway 10. Thus the electronic devices 12 and 13, each of the portable computer or laptop type, are respectively connected to the network gateway 10 by means of cable connections 120 and 130. The cable connections 120 and 130 are for example connections of the Ethernet type. The electronic devices 14 and 16 are smartphones, respectively connected to the network gateway 10 by means of wireless connections 140 and 160 established via an antenna system 111 of the network gateway 10. The antenna system 111 is connected to a communication module 115 internal to the network gateway 10, configured for cable connections and wireless connections (not shown in FIG. 1 but visible in FIG. 6). A portable computer or laptop 15 is also connected to the network gateway 10, and to the local area network 1 by means of a wireless connection 150, using the antenna system 111. A storage device of the NAS type (the acronym for “Network Attached Storage”) 17 is also connected to the network gateway 10, by means of a link 171. The link 171 is for example a cable link of the Ethernet type. In the examples of the present description given below, the local area network 1, implemented in a home, is made available for four users 2, 3, 4 and 5. The user 2 is defined as being the main user of the laptop 12. In a similar manner, the user 3 is the main user of the laptop 13. The user 4 is the main user of the smartphone 14 and of the laptop 15, and the user 5 is the main user of the smartphone 16 but however regularly uses each of the electronic devices described, since he administers the local area network 1. Here “main user” of a device means a user who operates the majority of the uses and accesses in relation to the local area network 1 by means of this device, although he also has access to the other devices described, but makes more occasional use thereof. According to one embodiment of the invention, the network gateway 10 comprises a device 100, referred to as a “key store”, for securing access to a computer-file storage space STM of the storage device 17. This storage space STM of the storage device 17 is designed and configured for a secure storage of computer files of various users 2, 3, 4 and 5. The computer files concerned may be of any nature, such as documents in the form of text, photographs, sound or video recordings, spreadsheet folders, or illustrations or drawings for example. The term “secure storage” is to be interpreted here as the storage in encrypted form of the files that the user wishes to be able to store, accompanied by an authentication of any user wishing to access one or more of these files. Advantageously and according to the invention, the key store 100 implements a centralised management of asymmetric-encryption keys for each of the users working on one or other of the electronic devices 12, 13, 14, 15 or 16. The centralised management of the encryption keys comprises equally well the generation of pairs of keys useful for the encryption and deciphering of files, for the encryption and deciphering of file encryption keys, and for the storage of these keys in a space called a “safe”, as well as the revocation of keys in accordance with predetermined criteria. The key store 100 furthermore performs operations of encrypting and deciphering computer files or encryption keys, as well as operations of storing these files in the file storage space STM. Finally, the key store 100 manages a list FL of encrypted files stored under its control. According to one embodiment, the key store 100 may also make available to a user, by transfer, a file in its encrypted form, so that the user can decipher it subsequently, by means of a private key. According to one embodiment of the invention, a pair of encryption keys referred to respectively as public and private allowing secure storage of files can be generated by each of the users of the key store 100, identified in combination with an electronic device, and which wishes to store one or more encrypted files in the computer-file storage space STM. Thus a given client corresponds either to a user such as one of the users 2, 3, 4, 5, or a user considered in combination with a device such as one of the electronic devices 12, 13, 14, 15 and 16. In the remainder of the description, a “client” of the key store 100 is defined as a user among the users 2, 3, 4 and 5 combined with one of the electronic devices among the electronic devices 12, 13, 14, 15 and 16, or as one of the users 2, 3, 4 and 5 considered independently of the electronic device that he is using.

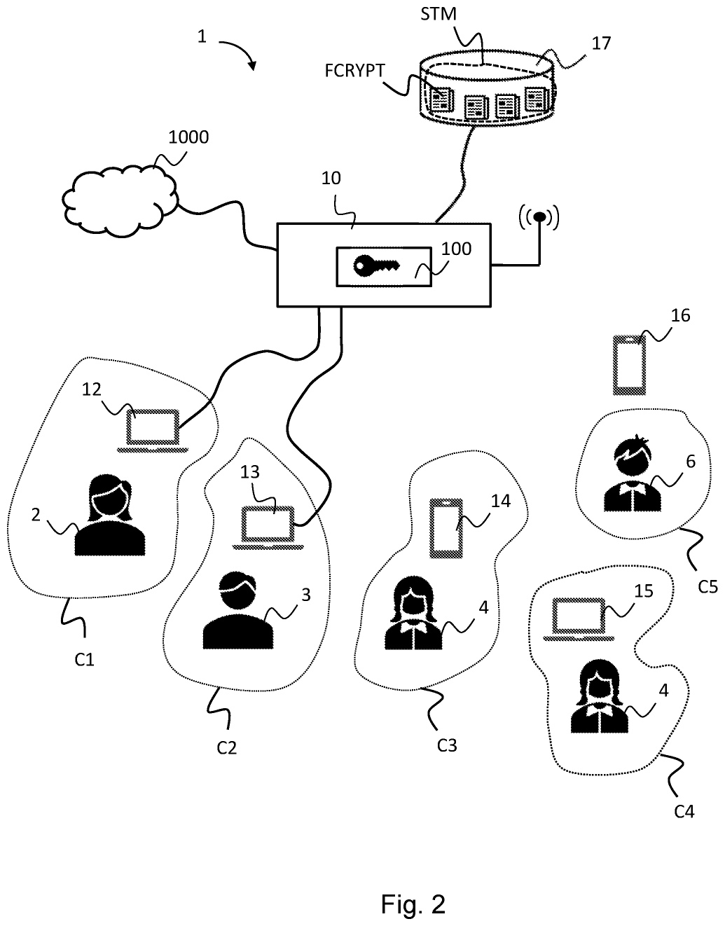

FIG. 2 illustrates the concept of “clients” of the key store 100 and shows a first client C1 as being the association (or combination) of the user 2 operating via the laptop 12. In the same manner a client C2 is defined as being the association of the user 3 operating via the laptop 13, a client C4 is defined as being the user 4 operating via the smartphone 14, a client C5 is defined as being this same user 4 operating via the laptop 15, and a client C5 is defined as being the user 5, whatever the device that he is using for implementing accesses in relation to the key store 100. FIG. 2 furthermore illustrates a plurality of files stored in the storage space STM of the storage device 17 of the NAS type, connected to the network gateway 10, one of which, FCRYPT, is an encrypted version of a native file F.

Advantageously, each client Ci thus defined is identified and represented by a unique client identifier CIDi. According to one embodiment, the unique identifier CIDi of a client comprises the MAC address of the equipment that he is using as well as a username of the client, for example in the form of a concatenation of these elements. According to one embodiment of the invention, the accesses to the files stored in the storage space of the storage device 17, implemented by means of the key store 100, are made by the users by means of an application known as a “client application”. Thus a client application is an interface enabling a client (and therefore a user) to access the encryption and storage service offer implemented by the key store 100 associated with the dedicated storage space STM. According to one embodiment, the client application is implemented in the form of a web page accessible from an internet browser, and this web page is instantiated by a web server embedded in the network gateway 10, or directly in the key store 100. According to a variant, the client application can take the form of an application dedicated to a use on a smartphone or can be in the form of a program executed on a fixed computer or laptop. Whatever the form that the client application takes, it must have access to a storage space dedicated to the recording of the deciphering keys that are transmitted to it by the key store 100 and that are adapted to the decryption of one or more files, where applicable. This storage space is called the safe of the key store 100.

According to one embodiment of the invention, each client Ci using the key store 100 for implementing a storage of a file in encrypted form or an access in read mode to a file, in a form that is encrypted (without deciphering by the key store 100) or deciphered (by means of the key store 100), must be authenticated by the key store 100. For this purpose, a client who uses the client application identifies himself by entering a username and a password for example. According to one embodiment, the key store 100 comprises a list of authorised passwords, coupled with user identifiers. According to a variant, the passwords are stored by the key store 100 in encrypted form, i.e. the key store 100 comprises a list of user identifiers each being associated with a hash of its password, which makes it possible not to store the passwords in clear, and increases the security of the elements and of the method for authenticating the users. According to another variant of the embodiment, the passwords of the users are encrypted by adding a salt to the initial password, so that the encryption is applied to a concatenation of the password and of the salt, the salt being a series of random numbers or alphanumeric elements. Advantageously, this further increases the degree of security of the authentication method and of the elements used for implementing this method.

According to one embodiment of the invention, the generation of the keys and the encryption and deciphering operations performed by the encryption and storage method described are based on the properties of an asymmetric-encryption algorithm such as for example the RSA algorithm (the acronym coming from the name of its inventors). The algorithm uses, for each of the clients authorised to store a file in encrypted form or to access a file in encrypted form, a pair of keys referred to respectively as public and private. These two keys are linked together by a mathematical relationship, in accordance with the RSA algorithm, so that a private key must be known only to its addressee (i.e., one of the clients of the key store 100), the public key for its part being known to the key store 100. According to one embodiment, the key store 100 comprises a secure environment making it possible to store the public keys in complete security. Such a secure environment is for example an environment of the TEE type (the acronym for Trusted Execution Environment) dedicated to the secure storage of information and to the performance of cryptographic operations, also commonly referred to as TrustZone. This type of secure environment is for example obtained by implementing tools as defined according to the OPTEE (a project of the open source type, which is aimed at implementing a complete solution of the TEE type).

According to the asymmetric-encryption principle used, and considering a pair of keys e_{c} and d_{d} respectively public and private, if Crypt is a predetermined encryption function and Decrypt is a predetermined deciphering function, then, for any message m of a computer data file to be stored, m=Crypt (Decrypt (m, d_{d}), e_{c}). A signature scheme can be constructed from this cryptography system.

According to one embodiment of the invention, the key store generates a pair of public and private keys for any identified and authenticated client wishing to store a computer file or a plurality of computer files by means of the encryption and storage service implemented by the key store 100 combined with a dedicated storage space.

Thus, if a client (a user, or a user considered in combination with an electronic device that he is using) connects and is authenticated without holding a pair of keys referred to respectively as public and private, then the key store 100 generates a pair of keys and attributes it to this client. According to one embodiment, a set of keys can be generated in advance by the key store 100, so that then only an attribution has to be made, when necessary, which affords a saving in time.

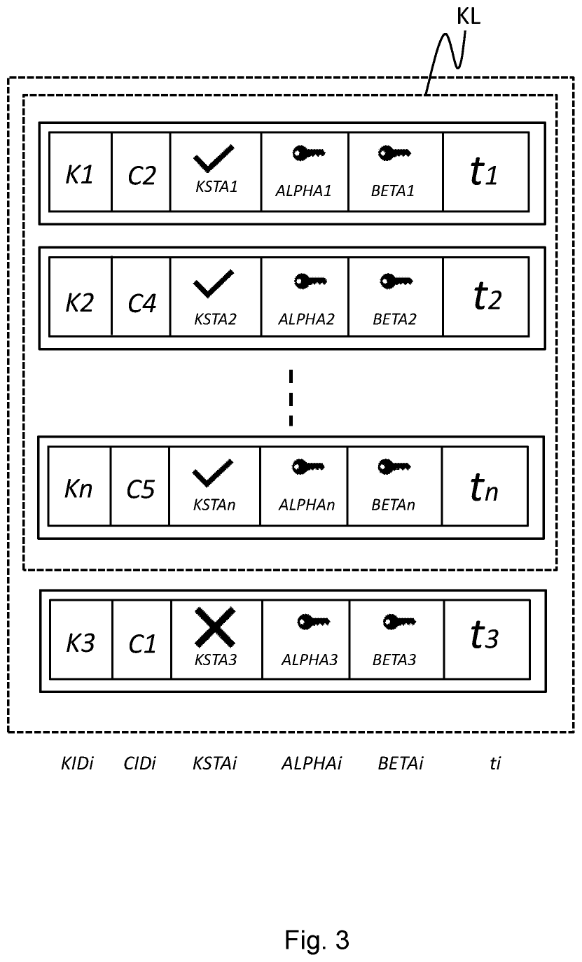

FIG. 3 shows a list KL of pairs of keys referred to respectively as public and private making it possible to grant access rights to one or more clients of the key store, connected thereto and operating by means of a client application available for example on a smartphone, a laptop, a fixed computer or any other electronic device configured to do this. The list KL of pairs of keys is stored in the safe of the key store 100. It should be noted that the list KL comprises the pair of keys attributed to clients authorised to achieve access to files by means of the key store 100. Other pairs of keys may be present in the container of the key store 100, such as pairs of keys not yet attributed or revoked pairs of keys. The latter are however not included in the list KL, which, by definition, contains the pairs of keys of clients authorised to access a computer file via the key store 100.

According to the preferred embodiment, each of the pairs of keys is composed of a private key ALPHAi and a public key BETAi respectively linked together by an encryption algorithm as previously described. Each of these pairs of keys is associated with a unique identifier CIDi of an i^{th} client Ci authorised to access at least one computer file F that is stored or that it is preparing to store via the key store 100. FIG. 3 shows n pairs of keys and illustrates a first pair of keys ALPHA1 and BETA1 associated with the client C2, i.e. with the user 3 operating via the laptop 13, according to the example described on FIG. 2. FIG. 3 also illustrates a second pair of keys ALPHA2 and BETA2 associated with the client C4, i.e. with the user 4 operating via the laptop 15, as well as a third pair of keys ALPHA 3 and BETA 3 associated with the client C1 and an n^{th} pair of keys ALPHAn and BETAn associated with the client C5, i.e. with the user 5 independently of the electronic device that he is using, as explained previously. Each of the n current pairs of keys stored in the safe of the key store 100 is furthermore associated with a unique key identifier KIDi. Thus the first pair of keys, associated with the client C2, is associated with a unique identifier KID1 of a pair of keys “K1”. In a similar manner, the second pair of keys, associated with the client C4, i.e. with the user 4 using the laptop 15, is associated with a unique identifier KID2 “K2”, and so on. Advantageously each pair of keys, or in other words each of the recordings of the safe comprising a pair of keys ALPHAi and BETAi, contains a status indicator KSTAi defined for indicating whether the pair of keys ALPHAi and BETAi is valid or revoked. Thus all the pairs of keys having a status indicator KSTAi indicating that the key is valid (not revoked) and being attributed to a client Ci make up the list KL. Other pair of keys, generated but not yet attributed, or revoked, may be present in the safe of the key store 100, but they do not then, by definition, belong to the list KL. On FIG. 3 a valid pair of keys comprises an indicator of the “ticked” pictogram type for signifying that the key is valid and a pair of revoked keys comprises an indicator of the “crossed” pictogram type for signifying that the key in question has been revoked. Obviously the status indicator KSTAi of a pair of keys ALPHAi and BETAi may be coded otherwise (for example 1 for valid and 0 for revoked). Thus, and according to the example illustrated on FIG. 3, the pairs of keys K1, K2 and Kn are valid and the pair of keys K3 is revoked, i.e. considered to be invalid after having been used or, at the very least, after having been generated. Advantageously, each of the recordings of the safe of the key store 100 also comprises time information ti that codes the instant of the last use of the services offered by the key store 100 by the client Ci concerned, in other words the last connection of this client Ci to the key store 100 for the purpose of storing an encrypted version FCRYPT of a computer file F or for the purposes of accessing this file F in read mode or for deleting it. Thus the information t1 comprises for example the date and time of the last connection of the client C2 to the key store 100 with a view to using the functions of encryption and storage in the storage space. Advantageously, it is thus possible for the key store 100 to automatically revoke a pair of identified keys Ki provided that the latter has not been used in an interval of time that has elapsed since the instant ti of the last use thereof or for example as soon as a predetermined time has elapsed since this pair of keys was generated by the key store 100. Obviously, the aforementioned time elements are not the only cause of revocation of an identified pair of keys Ki and a user losing control of an electronic device that he is using (loss, theft, degradation, breakdown) constitutes for example a cause of possible revocation. More generally, any management policy may be used for defining rules aimed at revoking a pair of keys ALPHAi and BETAi according to predetermined criteria, for example natively or according to established criteria. According to one embodiment of the invention, a pair of keys may be revoked by an operator having privileges to do so, for example a user identified as being an administrator of the key store 100 and who possesses rights of writing an identified pair of keys Ki on the status indicator KSTAi.

According to the preferred embodiment, the key store 100 furthermore manages a list FL of computer files Fi for which each of the computer files Fi is stored in encrypted form in the storage space STM under its control, or will be so in so far as a client Ci comes to connect with a view to storing a new computer file.

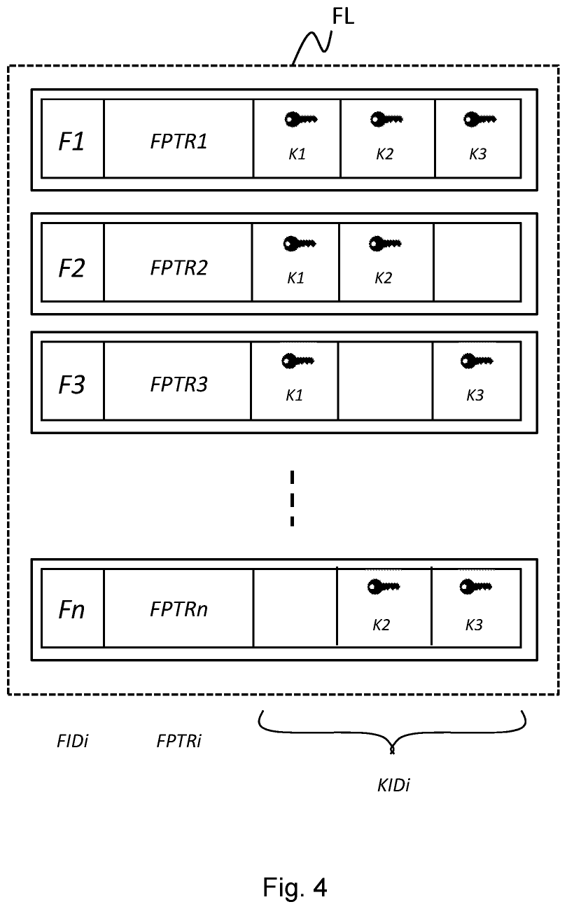

FIG. 4 shows a list FL of computer files Fi managed by the key store 100. Each of the recordings corresponding respectively to the computer files Fi is associated with a computer file identifier and an access pointer FPTRi to an encrypted version FCRYPTi of the computer file Fi stored in the storage space managed by the key store 100, or on the point of being stored under the control thereof. According to one embodiment of the invention, a pointer FPTRi is implemented in the form of a URL (the abbreviation for “Uniform Resource Locator”) address. According to one embodiment, a pointer FPTRi is used by the key store 100 implementing transfers of encrypted versions of the files Fi the encryption and storage of which it manages, using the SCP (the abbreviation for “Secure Copy Protocol”) transfer protocol.

Obviously, the use of this protocol is not limitative and any other secure transfer means can be implemented between the key store 100 and the storage space STM the management and securing of which it ensures.

Each of the recordings corresponding respectively to the encrypted computer files Fi an encrypted version of which FCRYPTi stored under the control of the key store 100 furthermore comprises a list of unique identifiers of pairs of keys associated with the clients authorised to access the encrypted version FCRYPTi of the file Fi to which it refers. Thus, according to the example described on FIG. 4, the identified computer file F1 can be read or modified by the clients respectively associated with the pairs of keys K1, K2 and K3; the identified computer file F2 can be read or modified by the clients respectively associated with the pairs of keys K1 and K2; the identified computer file F3 can be read or modified by the clients respectively associated with the pairs of keys K1 and K3; and the computer file Fn can be read or modified by the clients respectively associated with the pairs of keys K2 and K3. A modification of a file Fi here comprises the updating or deletion thereof. According to one embodiment, a client possessing rights for reading a file Fi or accessing an encrypted version FCRYPTi of a file Fi also possesses rights for deleting the computer file Fi or replacing the encrypted computer file Fi with a new version. According to a variant, only a client having sufficient privileges can modify and/or delete a computer file Fi (or more exactly the encrypted version of this computer file Fi), for example a user identified as being an administrator of the key store 100. Cleverly, a computer file F that must be stored by a client in the storage space managed by the key store 100 is encrypted using a symmetric encryption key SK, said key SK then being encrypted in as many encrypted versions as there exist clients authorised to access the computer file F, using respectively, for encrypting each of the encrypted versions of the key SK, the public key BETAi of each of the authorised clients, available in the safe of the key store 100. The encrypted versions of the encryption key SK are next associated with the encrypted version of the file F, being for example recorded in a header of the encrypted version FCRYPT of the computer file F, in association with the unique identifier CIDi of the client who is associated therewith and who can find the encryption key SK by deciphering the encrypted version thereof by means of his private key ALPHAi. Provided that a client can decipher the encryption key SK of the computer file F in its encrypted version FCRYPT, he can then decipher the encrypted version FCRYPT in order to find the original computer file F. According to a variant, the encrypted versions of the symmetric encryption key SK are stored not in a header of the file comprising an encrypted version FCRYPT of the computer file f, but at the end of this file, or in any other place in the file, in an organised manner and so that the encrypted versions of the encryption key SK are associated with the encrypted version FCRYPT, for example in the same data container.

According to another variant embodiment, the encrypted versions of the symmetric encryption key SK are not each associated directly in the file with the unique identifier of a client CIDi, but the organisation of the encrypted versions of the key SK in the file makes it possible to identify the client CIDi with whom each of the encrypted versions of the encryption key SK is associated. For example, the encrypted versions of the encryption key SK in a data container of the file containing the version FCRYPT of the computer file F follow each other in the same order as the identifiers of the pairs of keys ALPHAi, BETAi in the recording of the table FL managing the files of the key store 100, in connection with the computer file F.

The key store 100 therefore implements a method for encrypting and storing a computer file F to be stored in encrypted form by establishing (i.e. by creating or updating) the list KL of pairs of private ALPHAi and public BETAi keys, a list wherein each of the pairs of keys ALPHAi and BETAi is associated with a unique identifier CIDi of an i^{th} client authorised to access said computer file F, and then by receiving the computer file F and encrypting it as an encrypted version FCRYPT by means of a symmetric encryption key SK of the computer file F, and then by encrypting this encryption key in as many encrypted versions as there exist clients authorised to access the computer file F, each of the encrypted versions of the encryption key SK being obtained by an encryption by means of the public encryption key BETAi of the pair of keys ALPHAi, BETAi of the client authorised for access, and to whom it is attributed.

Thus a client wishing to decipher an encrypted version FCRYPTi of a computer file Fi, first of all deciphers an encrypted version of the symmetric encryption key SK by means of his private key ALPHAi, and then, once the symmetric encryption key SK has been obtained, the client can decipher the encrypted version FCRYPTi of a file Fi to obtain the native file Fi. According to one embodiment of the invention, the symmetric encryption key SK is different for each of the files Fi encrypted by means of the key store 100.

Advantageously, a symmetric encryption key SK is generated randomly.

It should be noted that the aforementioned step of receiving the file consists in receiving the computer file F from the client by means of the client application when the file F is stored in an encrypted form for the first time, or at the time of an updating of this computer file F in the storage space (storage of a new version of the file), and that this step of receiving the computer file F consists in reading from the storage space STM and deciphering an encrypted version of the computer file F when an updating of the rights of one or more clients is implemented in the key store 100.

Next an encrypted version FCRYPT of the computer file F, encrypted by means of said encryption key SK of said computer file F, is recorded in the computer file storage space STM, accessible from the key store 100, and managed under the control of the latter, and then the key store 100 makes accessible, to each of the clients Ci authorised to access the computer file F, an encrypted version of the encryption key SK, which is associated (connected) with the public encryption key BETAi, by recording this encrypted version of the encryption key in a header or another part of the file, in association with a unique identifier of the client, in association with the public key BETAi, or by being identifiable from its position in the file. Finally, the key store 100 associates the file F, in the list FL of files Fi encrypted and stored under the control of the key store 100, with one or more unique identifiers KIDi of pairs of keys ALPHAi and BETAi, as well as a pointer FPTR to an encrypted version FCRYPT of the computer file F, recorded in the file storage space and comprising encrypted versions of its symmetric encryption key SK, in a header or another part of the file (of the encrypted version FCRYPT).

According to a variant of the embodiment, the store 100 too is identified as a client Ci authorised to access all the computer files Fi the encryption and storage of which it manages and has its own pair of keys respectively private ALPHAM and public BETAM. This makes it possible to mitigate the loss of a private key ALPHAi by one of the clients Ci. The public key BETAM is then systematically used for encrypting a file in so far as it forms part of the list of public keys of the list of pairs of keys associated with clients authorised for access. This variant enables the key store 100 to use its private key ALPHAM whenever it must decipher an encrypted version of a computer file Fi. This is because its private key ALPHAM enables it to decipher the encrypted version of the key SK that is associated therewith in the header of the encrypted version FCRYPT of the file F. This solution is particularly relevant in the case where the key store 100 does not keep a copy of the private keys ALPHAi communicated to the clients, and where the clients are then alone “responsible” for keeping their respective keys.

Advantageously, and because of the encryption and storage method described above, a revoked pair of keys is not used for encrypting and deciphering a computer file Fi (or more exactly its symmetric encryption key SK) according to the operating method described, and a client associated with a revoked pair of keys can therefore no longer decipher the encrypted version of a computer file Fi, since he can no longer decipher an encrypted version of the encryption key SK. The revocation of a pair of keys ALPHAi and BETAi comprises updating his status indicator KSTAi with an identifier indicating the revocation, but also removing the identifier of the revoked pair of keys from the list of unique identifiers of keys recorded as having access to any file in the list FL of files managed by the key store 100 that comprises this unique identifier of a pair of keys. According to one embodiment, a removal (deletion) of a pair of keys from the key store also constitutes a revocation of this key. According to one embodiment of the invention, a pair of keys ALPHAi, BETAi can be associated with a client only if the store 100 detects that this client is connected to the store 100 in a secure manner, by means of a client application, and from the local area network 1 of the LAN type. That is to say either via a cable connection or via a secure (encrypted) wireless connection. Thus, if the client application is executed on a device that is not connected to the local area network 1, but connected for example to the wide area network 1000, the key store 100 detects this non-local connection configuration and returns to the client an error message indicating that it is not possible to attribute a pair of keys to the client. The encryption and storage operation requested from the client who is not connected to the local area network 1 is then interrupted. Advantageously, each of the clients authorised for access by the key store 100 has a non-revoked private key ALPHAi that can be used for deciphering the encrypted version FCRYPTi of a computer file Fi that he wishes to be able to access, via the deciphering of the symmetric encryption key SK of the file. The client application, or a compatible third-party application, can therefore itself proceed with the deciphering of an encrypted version of the computer file Fi or obtain an already deciphered version, since it was first of all deciphered and then transmitted by the key store 100.

When a client requests the key store 100 to delete a computer file Fi the encryption and storage of which are implemented under the control of the key store 100, the key store 100 deletes the encrypted version FCRYPTi of the computer file Fi from the storage space and deletes the information relating to this computer file Fi from the list FL of computer files the encryption and storage of which are managed by the key store 100. According to one embodiment of the invention, only certain clients or certain users have the right to delete a computer file Fi managed by the key store 100, for example only those benefiting from the privileges of an administrator of the key store 100.

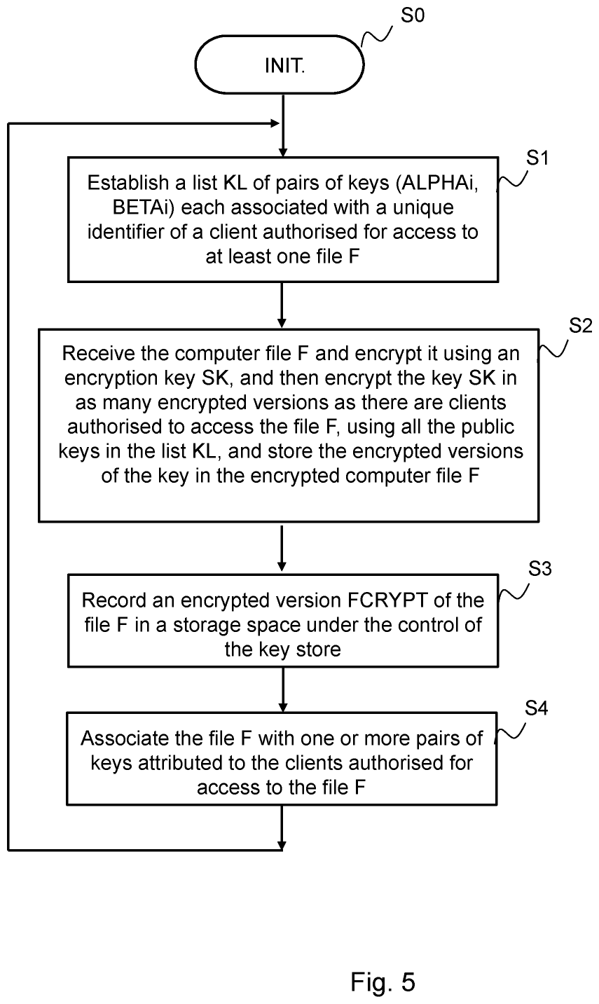

FIG. 5 is a flow diagram showing steps of the encryption and storage method using a list of keys ALPHAi and BETAi attributed to clients identified as being authorised to access the services implemented by the key store 100. A step S0 corresponds to a state wherein the electronic devices connected to the local area network 1 are operational and configured for interacting with each other in a nominal manner. In particular, the network gateway 10 is configured so as to enable the devices of a smartphone type and of a laptop type to connect to the local area network 1 of the LAN type. Furthermore, the network gateway 10 is configured for connecting the local area network 1 to the wide area network 1000, the key store 100 is configured for offering encryption and storage services to users authorised to access it and the file storage device 17 comprising the storage space STM is connected to the network gateway 10 and is normally operational. For example, the user 5, declared as administrator of the whole of the local area network 1, and therefore of the network gateway 10, created identifiers and passwords for himself and to each of the other users, so that they can identify themselves and have access to services offered and implemented by the network gateway 10, including in particular the encryption and storage method according to the invention.

According to the example of execution of the method that follows, the user 3 is identified on the laptop electronic device 13 by means of a client application configured for allowing the storage and encryption of computer files in the storage space STM of the storage device 17, by means of the key store 100 of the network gateway 10, said key store 100 advantageously allowing a centralised management of secure storage. According to this example, the user 3 prepares to store a computer file F1 in encrypted form, and under the control of the key store 100 of the gateway 10. The user 3 and the laptop electronic device 13 form in combination a client C2 according to the example shown on FIG. 2. The client C2 is identified by the key store 100 by means of a unique identifier which is, for example, an identifier of the user used for connection thereof to the client application, and the MAC address of the device that he is using, namely the laptop 13. The identifier may also be the password of the client, or an element derived from the password. According to this example, this client C2 has never yet performed an operation of connection to the key store 100 and has therefore, in fact, not implemented storage of any computer file by means of the services made available to him by the key store 100. According to one embodiment, when the client C2 thus connects to the key store 100, the key store 100 consults its list of pairs of keys and determines that the client 2 is not identified among the clients already authorised for access to at least one of the files available in the storage space of the storage device 17. The key store 100 then generates a pair of keys ALPHA 1 and BETA 1 respectively private and public and attributes it to the client C2. This pair of keys K1 is attributed by recording, in the list KL of clients authorised for access to the encryption and storage services, the pair of keys K1 in association with the unique identifier C2 or an encrypted version of this identifier. This recording operation constitutes an establishment, in a step S1 of the list KL of pairs of keys each associated with a unique identifier of a client authorised for access to the key store and to at least one file. Establishment of the list KL means here the creation of the list KL or an updating of this list KL. During his storage operation, the user 3 designates the computer file F to be stored by means of the client application with which he has identified himself, selecting it for example and indicating that he requires a storage of this file. This selection can be performed simply by means of an operation of clicking and dragging a representation of the file to a representation of the storage device 17 or of a representation of a dedicated storage space corresponding to a storage on the storage device 17, for example by means of a graphical user interface. Consequently the client application executed on the laptop 13 transmits the file F1 to the key store, which receives it in a step S2 and encrypts it as an encrypted version FCRYPT1 using a symmetric encryption key SK and encrypts the encryption key SK in as many encrypted versions as there are clients authorised to access the computer file F using respectively all the public keys BETAi of the pairs of keys associated with the clients identified as being authorised to access the file F1, or more exactly an encrypted version FCRYPT1 of the file F1, to store an updated version of this file or to delete it. In the case for example where the user 3 working on the laptop 13 is the only one to hold rights of access to the file F1, the file F1 is encrypted by means of the encryption key SK and this encryption key SK is in its turn encrypted by means of the public key BETA 1 of the pair of keys ALPHA 1, BETA1, and the encrypted version of the encryption key SK can be deciphered by means of the private key ALPHA1. The encrypted version FCRYPT1 is next recorded in a step S3 in the dedicated storage space STM of the storage device 17, under control of the key store 100 using for example the SCP file transfer protocol. The encrypted version of the encryption key SK, encrypted by means of the public key BETA1, is recorded in a header or another part of the file in encrypted form, in the storage space STM, which constitutes an association between the encrypted version of the key SK and the encrypted version FCRYPT1 of the file F1.

Finally, in a step S4, the key store 100 associates the file F1, with the pair of keys of client C2, in its internal list FL of files the management of which it provides in terms of encryption and storage, if the client C2 is the only one to hold rights of access to the file F1, or with all the pairs of keys associated with all the clients authorised for access to the file F1 if the client C2 is not the only one to hold rights of access to the file F1. The association between the file F1 and the pairs of keys of clients authorised for access to this file F1 is implemented by writing a unique identifier of each of the pairs of keys in a recording referencing the file F1 in the internal list of files FL.

Advantageously, and by virtue of the method described, adding or removing rights of access to an existing file Fi, for a given client Ci, can be achieved simply by establishing as required an updated version of the list KL of a pair of keys ALPHAi and BETAi, if the client Ci does not yet have a pair of keys or if the pair of keys that is attributed to him must be revoked, and by deciphering or re-encrypting the file Fi concerned, and then updating the list FL of files by associating the file Fi concerned with the pairs of keys ALPHAi and BETAi of the clients then authorised for access to the file Fi.

In the case where a modification of the rights of access to a file Fi is requested for a client Ci and the client Ci has already a pair of keys that is attributed to him and the latter is furthermore not to be revoked, the list of pairs of keys ALPHAi and BETAi of the authorised clients remains unchanged and only the table FL of the files managed by the key store 100 is updated. In this case, the encrypted version of the file concerned is all the same deciphered and re-encrypted with a second public key determined from all the public keys BETAi of the clients authorised for access.

Thus, whenever access rights are added or removed in relation to a file Fi, the encrypted version of the file Fi is deciphered and the file Fi is next re-encrypted as a new encrypted version FCRYPTi.

FIG. 6 illustrates schematically an example of internal architecture of the access-securing device, also referred to as a key store 100. It should be noted that FIG. 6 could also schematically illustrate an example of hardware architecture of the network gateway 10. According to the example of hardware architecture shown in FIG. 6, the key store 100 then comprises, connected by a communication bus 110: a processor or CPU (central processing unit) 119; a random access memory RAM 112; a read only memory ROM 113; a storage unit such as a hard disk (or a storage medium reader, such as an SD (Secure Digital) card reader 114; at least one communication interface 115 enabling the key store 100 to communicate with devices present in the communication network 1, such as for example the electronic devices 12, 13, 14, 15 and 16 or the file storage device 17 comprising the file storage space STM, this communication interface operating in combination with the antenna system 111.

The processor 119 is capable of executing instructions loaded in the RAM 112 from the ROM 113, from an external memory (not shown), from a storage medium (such as an SD card), or from a communication network. When the key store 100 is powered up, the processor 119 is capable of reading instructions from the RAM 112 and executing them. These instructions form a computer program causing the implementation, by the processor 119, of a part of a method described in relation to FIG. 5.

All or part of the method implemented by the key store 110, or described variants thereof, can be implemented in software form by executing a set of instructions by a programmable machine, for example a DSP (digital signal processor) or a microcontroller, or be implemented in hardware form by a machine or a dedicated component, for example an FPGA (field-programmable gate array) or an ASIC (application-specific integrated circuit). In general, the key store 100 comprises electronic circuitry configured for implementing the method described in relation to itself as well as to the electronic devices 12, 13, 14, 15, 16 and the file storage device 17 as well as any other device involved in executing the file encryption and storage method described. Obviously the key store 100 further comprises all the elements usually present in a system comprising a control unit and peripherals thereof, such as a power supply circuit, a power-supply monitoring circuit, one or more clock circuits, a reset circuit, input-output ports, switch inputs, bus drivers. This list is non-exhaustive.

The invention is not limited solely to the embodiments and examples described above. For example, the storage space managed by the key store 100 may be parcelled into a plurality of storage sub-spaces. According to another variant, the storage space managed by the key store 100 may be implemented outside a local area network, such as for example on a remote server located in the wide area network 1000 (a so-called Cloud server solution) and accessible by means of a secure connection. According to another variant, a plurality of storage spaces are managed by the key store 100 and are of different types (Cloud and NAS for example).

1.-10. (canceled)

11. A method for encrypting and storing a computer file, the method being implemented by a device, known as a “key store”, for securing accesses to said computer file, the key store being embedded in equipment of the home network gateway type, the method comprising:
establishing a list of n pairs of keys, each pair of keys comprising respectively a so-called private key and a so-called public key, wherein each of the pairs of keys is associated with a unique identifier of an i^{th} client authorised to access said computer file,
receiving said computer file and encrypting it as an encrypted version of said computer file, by means of a key for encrypting said computer file,
encrypting the encryption key in as many encrypted versions as there are public keys, each of the encrypted versions of the encryption key being encrypted with one of the public keys in the pairs of keys of the clients authorised to access the file,
recording an encrypted version of said computer file, encrypted by means of said key for encrypting said computer file, in a file storage space accessible from the key store, the encrypted version of the computer file being associated with the encrypted versions of the encryption key,
associating the file, in a list of files encrypted and stored under the control of said key store, with one or more unique identifiers of pairs of keys, as well as with a pointer to an encrypted version of said computer file recorded in the file storage space.

12. The method for encrypting and storing a computer file according to claim 11, wherein:
establishing the list of n pairs of keys comprises an addition of an n^{th} pair of keys associated with a unique identifier of an n^{th} client authorised to access the computer file in the list of pairs of keys, and/or wherein
an identifier of an i^{th} pair of keys is inserted in the list of encrypted files and stored by said key store, in association with said computer file for purposes of granting to an i^{th} client newly authorised to access the computer file a right of access to the computer file.

13. The method for encrypting and storing a computer file according to claim 11, wherein:
establishing the list of n pairs of keys comprises a removal of an i^{th} pair of keys associated with a unique identifier of an i^{th} client authorised to access the computer file in the list of pairs of keys, and/or wherein
an identifier of an i^{th} pair of keys is removed from the list of files encrypted and stored by said key store, in association with said computer file for the purpose of preventing the i^{th} client, previously authorised, having access to the computer file.

14. The method for encrypting and storing a computer file according to claim 11, wherein a unique identifier of a client comprises a user name and/or a password and/or a derivative of these elements.

15. The method for encrypting and storing a computer file according to claim 14, wherein one or more unique identifiers of a client comprise a unique identifier of a device used by a user of the key store.

16. The method for encrypting and storing a computer file according to claim 11, comprising a step of authenticating a client authorised to access said key store verifying that said client is connected to said key store device by means of a local area network of the LAN type, by means of a cable connection or an encrypted wireless connection.

17. A device, known as a “key store”, for securing access to at least one computer file, the key store being embedded in equipment of the home network gateway type and comprising electronic circuits comprising:
a module for establishing a list of n pairs of keys, each pair of keys comprising respectively a so-called private key and a so-called public key, wherein each of the pairs of keys is associated with a unique identifier of an i^{th} client authorised to access said computer file,
a communication interface configured for receiving said computer file and a module for encrypting said computer file as an encrypted version of said computer file, by means of a key for encrypting said computer file, and for encrypting the encryption key in as many encrypted versions as there are public keys, each of the encrypted versions of the encryption key being encrypted with one of the public keys of the pairs of keys of the clients authorised to access the file,
a module for recording an encrypted version of said computer file by means of said key for encrypting said computer file, in a file storage space accessible from the key store, the encrypted version of the computer file being associated with the encrypted versions of the encryption key,
a module for associating the file, in a list of files encrypted and stored under the control of said key store, with one or more unique identifiers of pairs of keys, as well as with a pointer to an encrypted version of said computer file recorded in the file storage space.

18. A computer program product, wherein it comprises program code instructions for executing the steps of claim 11, when said program is executed by a processor.

19. An information storage medium comprising a computer program product according to claim 11.
